(19) United States
(12) Patent Application Publication
(10) Pub. No.: US 2019/0055784 A1
(43) Pub. Date: Feb. 21, 2019

(54) Ladder Stabilizer and Leveler

(71) Applicant: David Kazanjian, Croydon, PA (US)

(72) Inventor: David Kazanjian, Croydon, PA (US)

(21) Appl. No.: 16/003,925

(22) Filed: Jun. 8, 2018

Related U.S. Application Data
(60) Provisional application No. 62/547,795, filed on Aug. 19, 2017.

(51) Int. Cl. E06C 7/42; E06C 1/06

(52) U.S. Cl. CPC E06C 7/423; E06C 1/06

(57) ABSTRACT

A ladder stabilizer comprises a pair of stabilizer brackets attached to the ladder side rails at the bottom on either side. Each bracket has a C-shaped clamping mechanism that utilizes a toothed gear rack which engages/disengages with mating teeth of a corresponding gear rack on the ladder rail. The gear-like engagement of the teeth provides a positive locking of the attachment member to the ladder. A spring and locking screw allow ease of adjustment and a positive lock at the desired location along the ladder side rail. The rack is attached longitudinally along the length of each rail to provide a range of length adjustment to the feet. This permits one side to be longer than the other to accommodate a laterally sloping terrain. The brackets have rotatable, laterally extending A-frames with ground-engaging feet which self-adjust to a terrain which is sloping from front-to-back or vice versa.

### RELATED APPLICATIONS

This is a non-provisional patent application related to provisional application No. 62/547,795 filed Aug. 19, 2017 entitled, “Ladder Stabilizer and Leveler” priority from which is hereby claimed.

### FIELD OF THE INVENTION

The present invention relates in general to a device which stabilizes a ladder to prevent it from tipping or slipping while in use. Furthermore it relates to those ladder stabilizers which also permit the base of the ladder to adjust to a sloping terrain to provide a level footing.

### BACKGROUND OF THE INVENTION

Due to the many accidents that are result of using ladders there have been many attempts to provide a ladder with at stabilizing feature at the base of the ladder. Professional painters, carpenters and utility workers who use ladders in their work daily are most often the victims of ladder accidents. Too, the average home owner has ladder falls due to their inexperience with proper ladder use.

Among the previous attempts to devise a safer ladder are those described in the following US patents: U.S. Pat. No. 2,371,460 issued to Needham; U.S. Pat. No. 4,792,017 issued to Grove; U.S. Pat. No. 4,069,893 issued to Blackstone; U.S. Pat. No. 3,025,926 issued to Vives; U.S. Pat. No. 5,423,397 issued to Boughner; and U.S. Pat. No. 5,551,529 issued to Molitor. Despite these many attempts to devise a more stable and safer ladder, no adequate solution has been found. The past devices are often difficult to operate and lack the strength to adequately support the weight of the ladder and the user if the ladder should tip to the side.

### SUMMARY OF THE INVENTION

In order to solve the problem of ladder safety which the art has not adequately addressed, the applicant has devised a superior safety ladder, or an accessory for an existing ladder, which overcomes the deficiencies in the field. As described in more detail below with regard to the drawings and description of the preferred embodiments, the new and improved ladder stabilizer provides a broad range of adjustability to accommodate many different footings in which ladders are often used. The present device can easily adjust to any sloping or uneven terrain while also providing a level and structurally strong lateral footing in all directions.

As described in more detail below, the applicant has devised supplemental feet affixed to the ladder rails by identical brackets, one on each side which function independent of one another. The brackets each have a laterally extendable outrigger arm which carries a pair of rotatable A-frames at its end. The two A-frames provide a four-point stance for the ladder.

A key feature of the invention is how it provides a structurally strong yet adjustable attachment of the supplemental feet to the ladder rails. Each bracket has a C-shaped clamping mechanism that utilizes a toothed rack that engages/disengages with mating teeth of a corresponding gear rack on the ladder rail. The gear-like engagement of the teeth provides a positive locking of the attachment member to the ladder. A spring and locking screw allow ease of adjustment and a positive lock at the desired location along the ladder side rail. The rack is attached longitudinally along the length of each rail to provide a range of length adjustment to the feet. This permits one side to be longer than the other to accommodate a laterally sloping terrain. Also, the rotatable A-frames self-adjust to a terrain which is sloping from front-to-back or vice versa. The outriggers are telescoping so that a broad stance can be provided by a compactable assembly that can be adjusted through a range of extension.

More specifically, the applicant has invented a ground-engaging stabilizer system for a ladder including a ladder comprising two side rails, a right and a left side rail, and a plurality of laterally extending interconnecting rungs between them, each side rail have a front, a backside and inward and outward facing sides. A first clamping bracket can be affixed to the left side rail of the ladder, said bracket having two opposed longitudinally extending runners, a first front runner and a second rear runner, and an outward facing mounting plate joining them. A first bracket at the left side has a first longitudinally extending mechanical engagement feature with a plurality of laterally projecting elements affixed to the second runner and adapted for engagement with second compatible engagement elements on a second engagement feature on the backside of the ladder left side rail. The bracket has a clamping screw threadably affixed to the first runner and adapted for engagement with the front of the ladder left side rail whereby rotation of the screw forces the first runner away from the front of the side rail thus forcing the second runner toward the backside of the rail to hold the first and second mechanical engagement features engaged. A compression spring is located between the front runner and the front of the ladder rail to bias the mechanical engagement features on the rear runner of the bracket toward engagement. A second clamping bracket being a mirror image of the first bracket is affixed to the right side rail of the ladder, said right side rail having third engagement features on the backside of the rail compatible with fourth engagement features on the rear runner of the second bracket. The mechanical engagement features on each of the brackets and each of the side rails can be matching gear racks each having a plurality of teeth extending side-by-side along the length of each of the mechanical engagement features.

To provide easy attachment and removal of the brackets the effective front-to-back clamping width between the front runner and the engagement features on the rear runner of each bracket is greater along a portion of the ladder side rail in an adjustment region adjacent the engagement features on each rail. The effective clamping width of other portions of the ladder side rail is narrower. The bracket is constructed such that the bracket is laterally captivated to the side rail only in the adjustment region by front and a rear captivation plates each affixed to one of the front and the rear runners respectively. The captivation plates operate against the inward facing side of the ladder side rail to laterally captivate the bracket to the ladder in the adjustment region. The bracket has a lateral opening between the captivation plates sufficient to allow narrower portions of the ladder rail not in the adjustment region to pass through. Easy removal of the brackets can be achieved by disengaging the clamp and sliding it upward to an area along the side rail above the adjustment region and then pulling it off to the side.

It should be understood that the embodiments described below in the drawings and description of the invention are exemplary and that a person skilled in the art may make many variations and modifications without departing from the spirit and scope of the invention. Accordingly, all such variations and modifications are intended to be included within the scope of the embodiments described herein.

### BRIEF DESCRIPTION OF THE DRAWINGS

FIG. 1 is a top left front isometric view showing the invention clamped to a ladder side rail.

FIGS. 2 and 3 are left side elevation sectional views showing the invention in locked and unlocked states, respectively.

FIG. 4 is a top plan view taken from FIG. 2 as shown in that Figure showing the invention clamped to the ladder in the locked position.

FIG. 5 is a top left front isometric view of an alternate embodiment of the invention.

### DETAILED DESCRIPTION OF PREFERRED EMBODIMENTS

One embodiment of the ladder stabilizer of the invention comprises two main parts clamped to opposite ladder side rails adjacent the bottom of a ladder by a unique clamping mechanism. Only the left side is shown in the drawings since a second right side is a mirror image of the left side and functions in the same way. Thus it is unnecessary for a complete understanding of the invention for both parts of the invention to be separately described, it being understood that the same structures shown here will also apply to the right side part functioning in the same way as its corresponding elements at the left. It will also be readily understood that since each side part of the pair can operate separately, the effective length of each side rail can be changed independently so that many different terrain variations can be accommodated.

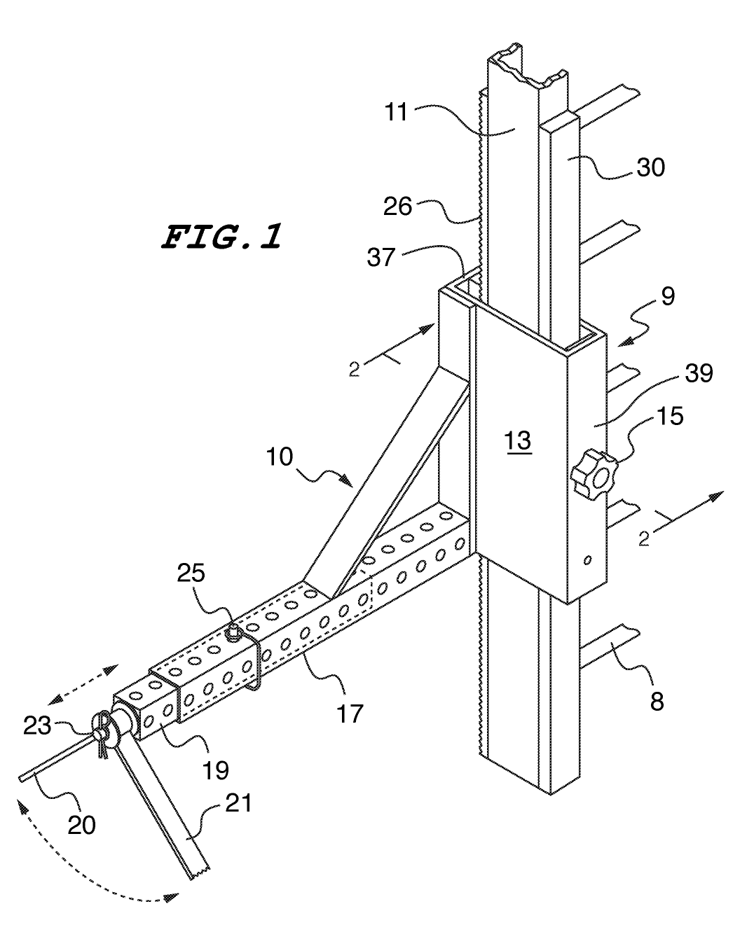

Referring now to FIG. 1, this embodiment of the invention is adapted for use with a common form of a ladder that has two parallel elongate side rails 11 interconnected by a series of rungs 8 between them. The right side rail is not shown here for the same reason explained above, namely that the ladder is symmetrical so that the right side rail an accompanying bracket is a mirror image of the left shown here. The left side of the stabilizer comprises clamping bracket 9 clamped to ladder side rail 11. The bracket 9 has an outward facing mounting plate 13 joining front and rear runners 39 and 37 which operate against a front and a backside of the rail, respectively. A telescoping lateral arm assembly 10 having inter-fitting members 17 and 19 is rigidly affixed to mounting plate 13. The inner telescoping member 19 carries a freely rotatable A-frame at the end having legs 20 and 21. The A-frame is releaseably secured to an axle 23 of the arm assembly by a cotter pin. The inner telescoping member 19 is held in position by a second pin 25 and may assume various degrees of locked extension away from the ladder side rail by passing the pin 25 through sets of aligned holes through the internal and external members when the desired amount of extension is selected. It will also be appreciated that constructed in this way the assembly can be easily disassembled for transportation.

The two legs of the A-frame, 20 and 21, have ground-engaging feet upon which the stabilizer stands. With the addition of the two other legs on a similar bracket on the other side of the ladder, a four-point stance of the stabilizer is created. Preferably the front leg 21 of the A-frame is longer that the other to accommodate the natural backward lean of the ladder. As will be further explained with regard to the following description, the clamp may be vertically positioned and locked to the ladder side rail by use of a toothed gear rack 26 affixed to the rear of the rail. The bracket is held in the locked position by a locking screw 15. With this construction the bracket 9 is slideably affixed to the side rail 11 so that the bottom ends of the ladder rails can be held above the supporting terrain. In that condition, the ladder can stand on the A-frame feet on each side providing a four-point stance. The ends of the legs may have shoes with features which provide enhanced grip.

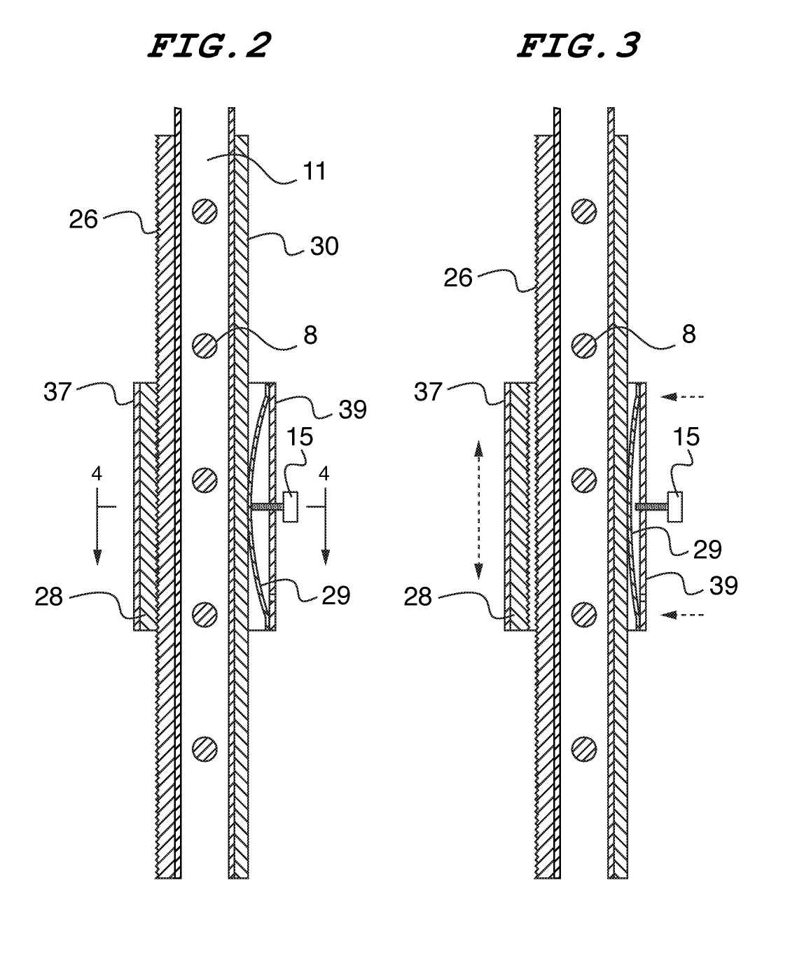

In FIGS. 2 and 3 the stabilizer clamping mechanism is shown in its locked and unlocked states, respectively. In its unlocked position it can be freely slide along the length of the ladder rail. Again, these same structures are coupled to the right side ladder rail, hence the ground-engaging A-frame feet can independently assume different vertical positions on the ladder rails to provide the ladder with a stable footing on an uneven or sloping terrain.

Referring now to FIG. 2, we see the left side of the stabilizer bracket pair which shows the interlocking of two mechanical engagement features, gear racks 26 and 28, each with teeth that mesh. Sensitive adjustment is possible because adjacent relative positions are only the distance of one tooth width apart. One gear rack 26 is affixed to the backside of side rail 11 and a second meshing gear rack 28 is affixed to the rear runner 37 of the bracket. The meshed gear teeth are secured together from being pulled apart by a locking screw 15 threaded through the front runner 39. Turning the screw 15 presses its end against spacer 30 and the front of the ladder rail pulling the gear rack on the rear runner 37 toward the backside of the rail forcing the teeth of gear racks 28 and 26 together. Safety leaf spring 29 is operative between the bracket front runner 39 and the front of the rail to bias the racks toward their engaged position when the screw 15 is loosened.

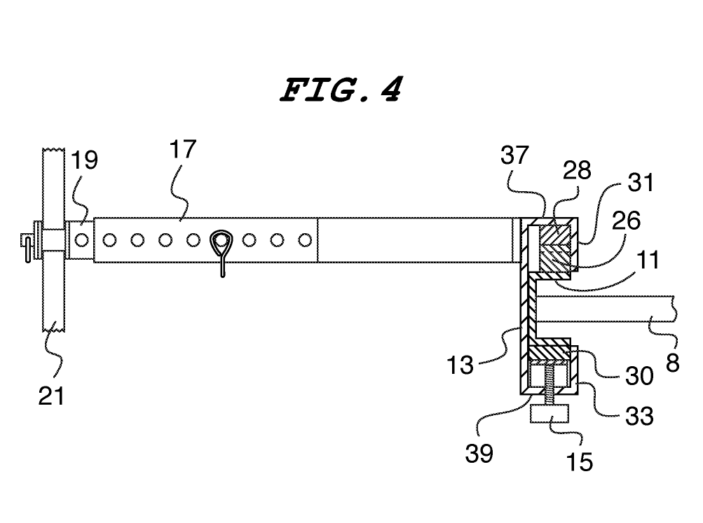

The screw 15 and the spring 29 bears against spacer strip 30 which is affixed to the front of the side rail opposite the gear rack. This added structure 30 increases the width of the ladder rail in this region to ensure that the clamp stays captivated to the ladder rail throughout the length of the adjustment stroke as explained in more detail below. As seen in FIG. 2 the effective clamping width of the ladder rail including the spacer 30 and gear rack 26 is greatest in the adjustment region. Above that region the effective clamping width is the unencumbered width of the ladder rail which is significantly less. As seen in FIG. 4 below this permits the removal of the bracket from the ladder rail through the inward facing open jaw of the bracket. Also, while gear racks are employed in this embodiment other forms of mechanical engagement features can be employed which are lighter weight and less expensive but which provide a more coarse adjustment.

In FIG. 3 we see that the screw 15 is unscrewed and by pressing against the bracket the spring 29 is depressed moving the bracket rearward thereby disengaging the gear racks 26 and 28. In this position the clamp has become unlocked and ready to assume a different vertical position by sliding it up or down to a new position on the rail. These motions are indicated by the arrows in this figure. When the desired new position is reached the laterally applied force will be relaxed and the screw tightened to complete the process.

These same steps can be repeated to remove the clamp from the ladder. The gear rack 26 and the spacer 30 are located only along a small portion of the ladder side rails adjacent their bottom ends where the stabilizer is to be located and adjustment desired. The rack 26 and spacer 30 increase the width of the side rail in the area of the adjustment stroke so that the clamp is captivated to the side rail only in this region. When the clamp is disengaged and lifted to a point along the side rail above the rack 26 and spacer 30, the clamp can be removed from the rail laterally from the side of the rail 11 by rotating it slightly as it is pulled off to the side. Thus the stabilizer brackets can be attached or removed without having to move the ladder.

Referring now to FIG. 4, we see the clamp bracket mounting plate 13 with extension arms 17 and 19 that carry the A-frame 21. The clamp bracket is C-shaped in cross-section and has captivation plates 31 and 33 that wrap around the sides of the rack 26 and spacer 30. With this configuration, the clamp has a lateral opening that faces inwardly. In this position of locked engagement between gear racks 26 and 28 the clamp cannot be pulled away from the ladder side rail because the effective clamping width of the assembly is wider than the clamp opening. If the clamp is lifted above the rack 26 and spacer 30 where the rail alone is narrower because it has not been enlarged by those added structures, then the clamp can be removed because after rotating the bracket slightly the rail can then pass through the lateral clamp opening. This process is reversed to put the stabilizer onto the side rail.

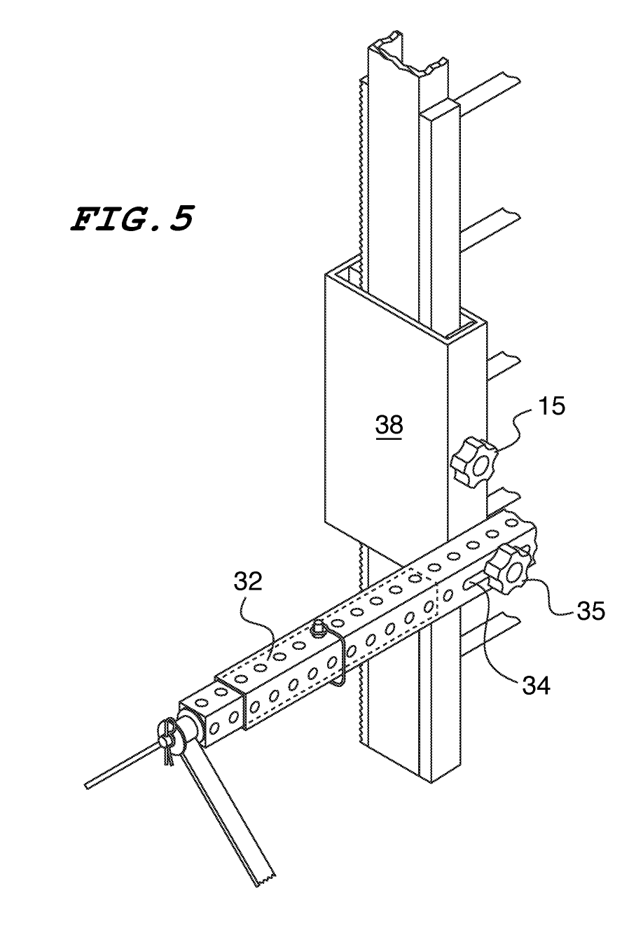

FIG. 5 illustrates an alternate embodiment of the invention which has been simplified so that it can be manufactured less expensively. All parts of the bracket clamping mechanism 38 are the same as in the previous embodiment shown in FIGS. 1-4 except that the separate lateral arms are replaced by a single crossbar 32 that spans across and beyond both sides of the ladder. Only the left side is shown here, but again the right side components are mirror images of those at the left. The crossbar 32 is connected to each clamp bracket depicted here by clamp bracket 38 on the left side of the ladder by an attachment screw 35, one on each clamp bracket. The crossbar 32 carries the same telescoping members and A-frames on opposite ends as in the previous embodiment. Independent vertical movement of the individual rail clamps is allowed by slots such as slot 34 shown here in the crossbar through which the clamp attachment screw 35 passes. The attachment slots accommodate the concomitant length change when the individual clamps are moved to different levels on their respective rails.

The embodiments of the invention described above can be constructed from a wide variety of materials including steel, plastic, aluminum or any other suitable material having the most desirable weight and strength characteristics. Different components may be made of different materials. For example the gear racks may be made of aluminum or steel while the rest of the components may be constructed from plastic.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to falling within the claims which alone shall determine the scope of the invention.

1. A ladder stabilizer, comprising:
a clamping bracket adapted for affixation to one side rail of a ladder, said bracket having two opposed longitudinally extending runners, a first front runner and a second rear runner, and an outwardly facing mounting plate joining them;
a first longitudinally extending mechanical engagement feature having a plurality of engagement elements affixed to the second runner and adapted for engagement with second compatible engagement elements on the rear of the ladder side rail; and
a clamping screw threadably affixed to the first runner and adapted for operation against the front of the ladder side rail whereby rotation of the screw forces the first runner away from the front of the side rail thus forcing the second runner toward the rear of the rail to hold the first and second mechanical engagement features engaged.

2. The device of claim 1 further including a compression spring located between the front runner and the front of the rail to bias the second runner toward a backside of the rail.

3. The device of claim 1 having a laterally extending arm assembly affixed to the mounting plate comprising a ground-engaging apparatus at a distal end thereof.

4. The device of claim 3 wherein the arm assembly comprises two telescoping arm members whereby the ground-engaging apparatus may be selectively secured at different positions away from the ladder rail.

5. The device of claim 1 wherein the first and second mechanical engagement features are matching gear racks each having a plurality of teeth extending side-by-side along the length of each mechanical engagement feature.

6. The device of claim 3 wherein the ground-engaging apparatus has two angled ground-engaging feet joined at the top at an apex which is rotatably affixed to the arm assembly.

7. A ladder stabilizer, comprising:
right and left side clamping brackets, each according to claim 1, being mirror images of each other, each adapted for slideable affixation to one of a left and a right side rail of a ladder respectively; and
a crossbar affixed to the left and right side brackets, said crossbar having opposite ends to which left side and right side ground-engaging apparatuses are affixed.

8. The device of claim 7 wherein the crossbar has two telescoping arm members whereby the ground-engaging apparatuses may be selectively secured at different positions away from the ladder rail.

9. The device of claim 7 wherein the first and second mechanical engagement features are matching gear racks each having a plurality of teeth extending side-by-side along the length of each mechanical engagement feature.

10. The device of claim 7 wherein the crossbar has lateral slots which receive bracket affixation screws.

11. The device of claim 1 in combination with a ladder to which it is affixed.

12. The device of claim 7 in combination with a ladder to which it is affixed.

13. The device of claim 11 wherein the front-to-back effective clamping width of a portion of the ladder side rail in a region adjacent the engagement features is greater than other portions of the ladder side rail such that the bracket is laterally captivated to the side rail only in that region by a front and a rear captivation plate each affixed to one of the front and the rear runners and having a lateral opening between them through which the side rail not in said region can pass.

14. The device of claim 7 wherein the front-to-back effective clamping width of a portion of the ladder side rail in a region adjacent the engagement features is greater than other portions of the ladder side rail such that the bracket is laterally captivated to the side rail only in that region by a front and a rear captivation plate each affixed to one of the front and the rear runners respectively, said bracket being C-shaped in cross-section having a lateral opening between the captivation plates through which the side rail not in said region can pass.

15. The device of claim 12 longitudinally extending mechanical engagement features, each having a gear rack affixed to the each of the bracket rear runners and adapted for engagement with matching gear racks on the backside of each of the ladder side rails.

16. In combination, a ladder and a ground-engaging stabilizer, comprising;
a ladder comprising two side rails, a right and a left side rail, and a plurality of laterally extending interconnecting rungs between them, each side rail have a front, a backside and inward and outward facing sides;
a first clamping bracket affixed to the left side rail of the ladder, said bracket having two opposed longitudinally extending runners, a first front runner and a second rear runner, and an outward facing mounting plate joining them;
said first bracket having a first longitudinally extending mechanical engagement feature with a plurality of laterally projecting elements affixed to the second runner and adapted for engagement with second compatible engagement elements on a second engagement feature on the backside of the ladder left side rail; and
said first bracket having a clamping screw threadably affixed to the first runner and adapted for engagement with the front of the ladder left side rail whereby rotation of the screw forces the first runner away from the front of the side rail thus forcing the second runner toward the rear of the rail to hold the first and second mechanical engagement features engaged.

17. The device of claim 16 further including a second clamping bracket being a mirror image of the first bracket affixed to the right side rail of the ladder, said right side rail having third engagement features on the backside of the rail compatible with fourth engagement features on the rear runner of the second bracket.

18. The device of claim 17 wherein the mechanical engagement features on each of the brackets and each of the side rails are matching gear racks each having a plurality of teeth extending side-by-side along the length of each of the mechanical engagement features.

19. The device of claim 16 wherein the effective front-to-back clamping width of a portion of the ladder side rail in a region adjacent the engagement features on each rail is greater than the width of other portions of the ladder side rail such that the bracket is laterally captivated to the side rail only in that region by front and a rear captivation plates each affixed to one of the front and the rear runners respectively, said plates engageable with the inward facing side of the ladder side rail to laterally captivate the bracket to the ladder in said region, said bracket having a lateral opening between the captivation plates through which portions of the ladder rail not in said region can pass.

20. The device of claim 17 further including a spring on each bracket located between the front runner and the front of the side rail to bias the mechanical engagement features on the rear runner of each bracket toward engagement.
